(19) United States
(12) Patent Application Publication
(10) Pub. No.: US 2009/0246412 A1
(43) Pub. Date: Oct. 1, 2009

(54) Localized deposition system and method of localized deposition

(76) Inventors: Peter Knowles, Elmira, NY (US); Mark Lawrence Powley, Campbell, NY (US); Robert Stephen Wagner, Corning, NY (US)

Correspondence Address: CORNING INCORPORATED, SP-TI-3-1, CORNING, NY, 14831, US

(21) Appl. No.: 12/079,518

(22) Filed: Mar. 27, 2008

(51) Int. Cl. H05B 6/00; B05C 11/00

(52) U.S. Cl. 427/596; 118/696

(57) ABSTRACT

A localized deposition system is provided comprising a substrate support, a feed material supply, a feedstock laser source, a substrate laser source, and a deposition control system. The feedstock laser source is configured to heat feed material positioned for localized deposition on the deposition surface of the substrate. The substrate laser source is configured to heat a localized portion of the substrate. The deposition control system is programmed to synchronize the relative movement between the deposition surface of the substrate and the localized deposition position of the feed material supply with operation of the feedstock laser source, the substrate laser source, and the feed material supply to execute a deposition operation. Methods of localized deposition are also provided.

### BACKGROUND OF THE INVENTION

The present invention relates to systems and methods for localized deposition of materials in the manufacture of relatively small scale structures. For example, and not by way of limitation, the systems and methods described and defined herein may be employed in the field of microfluidic devices.

Microfluidic devices may also be commonly referred to as microstructured devices, microchannel devices, microreactors, and the like. Regardless of the particular nomenclature utilized, the microfluidic device is a device in or on which a fluid, optionally including solids, can be held and subjected to processing. The fluid can be moving or static or both in turns, although it is typically moving. The processing may involve analysis of the fluid or solids, if any, reaction, heat exchange, other operations, or combinations of operations. The cross-sectional dimensions of channels or passages in such devices are typically on the order of millimeters or smaller. The small dimensions provide considerable improvement in mass and heat transfer rates over larger scale fluidic devices. Microfluidic devices thus offer many advantages over conventional scale reactors, including significant improvements in energy efficiency, reaction speed, reaction yield, safety, reliability, scalability, etc.

### BRIEF SUMMARY OF THE INVENTION

The present inventors have recognized a continuing need for improved systems and methods for manufacturing microfluidic devices and other small scale devices. According to one embodiment of the present invention, a localized deposition system is provided comprising a substrate support, a feed material supply, a feedstock laser source, a substrate laser source, and a deposition control system. The substrate support is configured to support a substrate such that a deposition surface of the substrate is in communication with the feed material supply. The feed material supply is configured to provide feed material for localized deposition at a localized portion on the deposition surface of the substrate. The localized deposition system is configured to provide for relative movement between the deposition surface of the substrate and a position in which the feed material is provided for localized deposition. The feedstock laser source is configured to heat feed material positioned for localized deposition on the deposition surface of the substrate. The substrate laser source is configured to heat a localized portion of the substrate. The deposition control system is programmed to synchronize the relative movement between the deposition surface of the substrate and the localized deposition position of the feed material supply with operation of the feedstock laser source, the substrate laser source, and the feed material supply to execute a deposition operation.

According to another embodiment of the present invention, a method of localized deposition is provided where the feed material supply provides a zero expansion glass or glass ceramic feed material for localized deposition and the substrate comprises a zero expansion glass or glass ceramic. The feedstock laser source is configured to generate a laser beam of sufficient thermal energy to heat a tip region of the glass or glass ceramic feed material to a temperature at which it can be bonded to the deposition surface of the glass or glass ceramic substrate through a thermal wetting process.

According to yet another embodiment of the present invention, a method of localized deposition is provided where the substrate laser source is used to heat a localized portion of the substrate and the substrate laser source is configured to generate a laser beam of sufficient thermal energy to contribute to the thermal wetting process by heating the localized portion of the substrate.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of a localized deposition system according to one embodiment of the present invention;

FIG. 2 is an illustration of a portion of a microfluidic device that may be fabricated in accordance with the present invention; and

FIG. 3 is a schematic illustration of a localized deposition system according to an alternative embodiment of the present invention.

### DETAILED DESCRIPTION

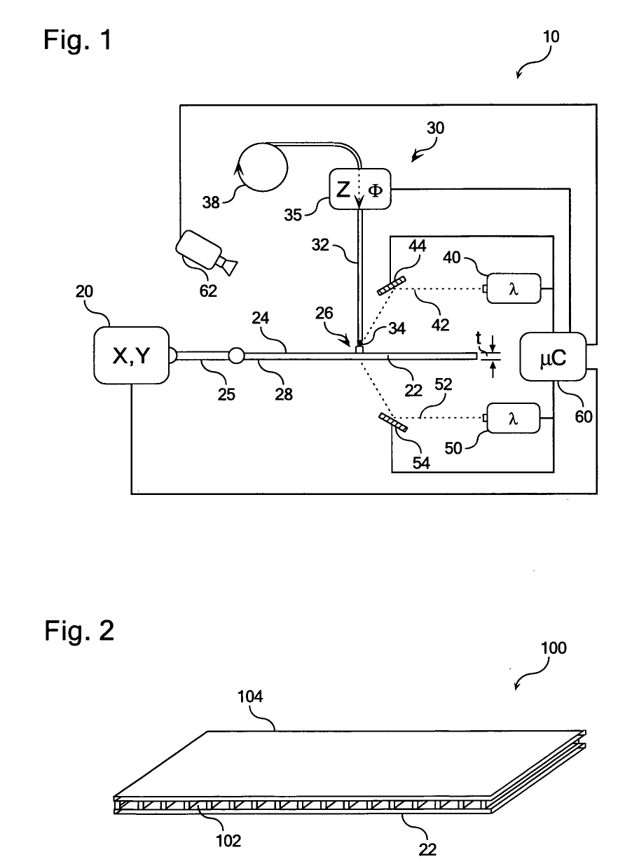

Referring initially to FIG. 1, a localized deposition system 10 according to one embodiment of the present invention is illustrated. The localized deposition system 10 comprises a substrate support 20, a feed material supply 30, a feedstock laser source 40, a substrate laser source 50, and a deposition control system including, for example, a programmable deposition controller 60 and a camera 62 positioned to monitor deposition operations.

The substrate support 20 is configured to support a substrate 22 such that a deposition surface 24 of the substrate 22 is in communication with the feed material supply 30. The feed material supply 30 is configured to provide feed material 32 for localized deposition at a localized portion 26 on the deposition surface 24 of the substrate 22. The feed material 32 may comprise a rod or fiber of fused silica glass, a fused quartz, a glass ceramic, a titanium silicate glass, or any other conventional or yet to be developed thermally compatible deposition material, and may be fed from a reel or spool 38.

In particular embodiments of the present invention, the feed material 32 comprises a glass or glass ceramic and is selected such that its coefficient of thermal expansion is approximately zero, although the present invention is not limited to the context of zero expansion materials. It may also be preferable to select the feed material 32 such that its coefficient of thermal expansion approximates or matches that of the substrate 22, in which case the substrate would typically comprise a glass or glass ceramic having a coefficient of thermal expansion that is approximately zero.

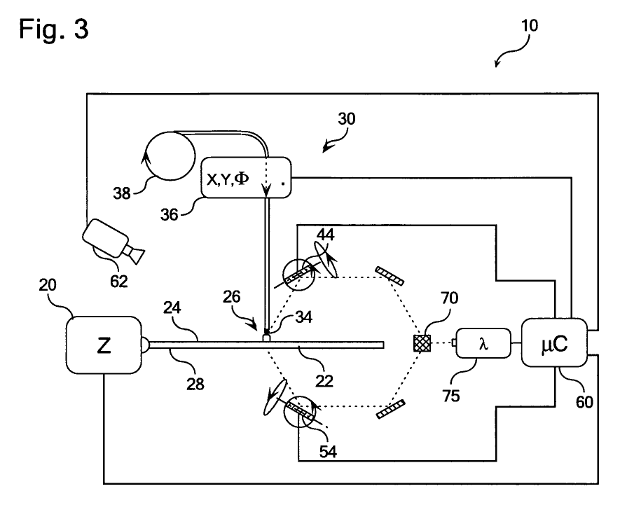

The localized deposition system 10 is configured to provide for relative movement between the deposition surface 24 of the substrate 22 and a position in which the feed material 32 is provided for localized deposition. For example, in the embodiment illustrated in FIG. 1, the substrate support 20 comprises a multi-dimensional substrate positioner 25 that provides for relative movement, in at least two dimensions, between the deposition surface 24 of the substrate 22 and the position at which the feed material 32 is provided for localized deposition. In addition, the feed material supply 30 comprises a Z-axis positioner 35 that provides for relative movement along a Z-axis that is approximately orthogonal to the deposition surface 24 and controls the rate Φ at which the feed material 32 is provided. Alternative configurations for providing the relative movement between the substrate and feed material supply 30 are contemplated including, but not limited to, those where the X, Y, and Z components of movement are provided solely by the substrate positioner 25 or the feed material supply 30. Additional detail regarding system modifications that may arise when the feed material supply 30 is provided with multi-dimensional positioning capability are described in further detail with reference to FIG. 3, below.

The feedstock laser source 40 is configured to heat feed material 32 positioned for localized deposition on the deposition surface 24 of the substrate 22. The feedstock laser source 40 is configured to generate a laser beam 42 of sufficient thermal energy to heat a tip region 34 of the feed material 32 to a temperature at which it can be bonded to the deposition surface 24 of the substrate 22 through a thermal wetting process, i.e., a melting or softening temperature of the feed material 32. To aid in set-up or calibration, the feedstock laser source 40 may be provided with controllable beam steering optics 44, e.g., a dual-axis, gimbal-mounted, heat resistant MEMS mirror.

The substrate laser source 50 is configured such that a backside surface 28 of the substrate 22 is positioned in a field of view of the substrate laser source 50 and is configured to generate a laser beam 52 of sufficient thermal energy to contribute to the thermal wetting process by heating the localized portion 26 of the substrate 22. To aid in set-up or calibration, the substrate laser source 50 may be provided with controllable beam steering optics 54, e.g., a dual-axis, gimbal-mounted, heat resistant MEMS mirror.

In the illustrated embodiment, the substrate laser source 50 is configured such that localized heating of the substrate 22 by the substrate laser source 50 progresses from the backside surface 28 of the substrate 22 to the deposition surface 24 of the substrate 22 through a thickness dimension t of the substrate 22. Under this configuration, and where the substrate 22 is fabricated from materials exhibiting thermal conductivities between approximately 1.0 Wm⁻¹K⁻¹ and approximately 1.4 Wm⁻¹K⁻¹ and having thickness dimensions t less than approximately 4 mm, the substrate laser source 50 can be conveniently configured such that the localized heating of the substrate 22 at the deposition surface 24 will rapidly exceed approximately 1500° C. and can readily reach 2000° C.-2500° C., or higher. Suitable substrate materials include, but are not limited to, fused silica glass, fused quartz, glass ceramics, titanium silicate glass, etc.

The deposition control system, which may comprise a network of dedicated programmable controllers or the single programmable deposition controller 60 in communication with the substrate support 20, the feed material supply 30, the feedstock laser source 40, and the substrate laser source 50, is programmed to synchronize the relative movement between the substrate 22 and the tip region 34 of the feed material supply 30 with operation of the feedstock laser source 40, the substrate laser source 50, and the feed material supply 30 to execute a synchronized deposition operation. More specifically, the deposition control system can be programmed to maintain equilibrium mass flow and uniform deposition. Further, and by way of example, not limitation, the deposition control system can be programmed to establish the relative movement of the substrate 22 and the tip region 34 of the feed material supply 30 at an approximately constant velocity or to synchronize changes in the velocity of the relative movement of the substrate 22 and the tip region 34 with changes in a rate at which the feed material supply 30 provides the feed material 32.

Further, the deposition control system can be programmed to maintain the localized deposition position 26 in approximate alignment with the position at which a beam 52 of the substrate laser source 50 contacts the substrate 22. Alternatively, to accommodate for any delay in the transmission of heat to the deposition surface 24, the deposition control system can be programmed to maintain the localized deposition position 26 in offset alignment with the position at which the beam 52 of the substrate laser source 50 contacts the substrate 22. In which case, the offset alignment could be set such that the position at which the substrate laser beam 52 contacts the substrate 22 leads the localized deposition position 26 during relative movement between the substrate 22 and the tip region 34.

FIG. 2 is an illustration of a portion of a microfluidic device 100 that may be fabricated utilizing the systems and methodology contemplated herein. As is illustrated, the microfluidic device 100 comprises a plurality of partially or fully contained microfluidic device channels 102, the configuration of which is illustrated in an overly simplified manner in FIG. 2 because the precise configuration of the microfluidic device pattern defined by the microfluidic device channels 102 is beyond the scope of the present invention and may be gleaned from conventional and yet to be developed teachings on the subject. Regardless of the specific microfluidic device pattern in use, a cover plate 104 is secured over the microfluidic device pattern through, for example, localized heating and pressure, to define the microfluidic device channels 102.

FIG. 3 illustrates a localized deposition system 10 where the feed material supply 30 comprises a multi-dimensional feed positioner 36 that provides for relative movement, in at least two dimensions X, Y, between the deposition surface 24 of the substrate 22 and the tip region 34 of the feed material supply 30. In this embodiment, because the tip region 34 of the feed material supply 30 is not stationary, the feedstock laser source 40 and the substrate laser source 50 may be provided with controllable beam steering optics 44, 54, e.g., a pair of dual-axis, gimbal-mounted, heat resistant mirrors, configured to track the movement of the tip region 34.

FIG. 3 also illustrates the case where the feedstock laser source and the substrate laser source comprise beam splitting optics 70 in communication with a common laser 75, as opposed to the pair of stand-alone lasers 40, 50 illustrated in FIG. 1.

It is noted that terms like “preferably,” “commonly,” and “typically,” if utilized herein, should not be read to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the terms “approximately” and “substantially” are utilized herein to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “programmed” in a particular way, “configured” or “programmed” to embody a particular property, or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A localized deposition system comprising a substrate support, a feed material supply, a feedstock laser source, a substrate laser source, and a deposition control system, wherein:
the substrate support is configured to support a substrate such that a deposition surface of the substrate is in communication with the feed material supply;
the feed material supply is configured to provide feed material for localized deposition at a localized portion on the deposition surface of the substrate;
the localized deposition system is configured to provide for relative movement between the deposition surface of the substrate and a position in which the feed material is provided for localized deposition;
the feedstock laser source is configured to heat feed material positioned for localized deposition on the deposition surface of the substrate;
the substrate laser source is configured to heat a localized portion of the substrate; and
the deposition control system is programmed to synchronize the relative movement between the deposition surface of the substrate and the localized deposition position of the feed material supply with operation of the feedstock laser source, the substrate laser source, and the feed material supply to execute a deposition operation.

2. A localized deposition system as claimed in claim 1 wherein the substrate laser source is configured such that localized heating of the substrate by the substrate laser source progresses from a backside surface of the substrate to the deposition surface of the substrate through a thickness dimension of the substrate.

3. A localized deposition system as claimed in claim 2 wherein the substrate comprises a fused silica glass substrate, a fused quartz substrate, a glass ceramic substrate, or a titanium silicate glass substrate.

4. A localized deposition system as claimed in claim 1 wherein the substrate laser source is configured such that a backside surface of the substrate is positioned in a field of view of the substrate laser source.

5. A localized deposition system as claimed in claim 1 wherein the deposition control system is programmed to control the feed material supply, the feedstock laser source, the substrate laser source, and the relative movement of the substrate and the feed material supply to maintain equilibrium mass flow and uniform deposition.

6. A localized deposition system as claimed in claim 5 wherein the deposition control system is programmed to maintain equilibrium mass flow and uniform deposition by establishing the relative movement of the substrate and the feed material supply at an approximately constant velocity or by synchronizing changes in the velocity of the relative movement of the substrate and the feed material supply with changes in a rate at which the feed material supply provides the feed material.

7. A localized deposition system as claimed in claim 1 wherein the deposition control system is programmed to maintain the localized deposition position in approximate alignment with a position at which a beam of the substrate laser source contacts the substrate.

8. A localized deposition system as claimed in claim 1 wherein the deposition control system is programmed to maintain the localized deposition position in offset alignment with a position at which a beam of the substrate laser source contacts the substrate.

9. A localized deposition system as claimed in claim 8 wherein the offset alignment is such that the position at which the substrate laser beam contacts the substrate leads the localized deposition position during the relative movement.

10. A localized deposition system as claimed in claim 1 wherein the feed material comprises a rod or fiber of fused silica glass, a fused quartz, a glass ceramic, or a titanium silicate glass.

11. A localized deposition system as claimed in claim 1 wherein the coefficient of thermal expansion of the feed material is approximately zero.

12. A localized deposition system as claimed in claim 1 wherein the respective coefficients of thermal expansion of the feed material and the substrate are approximately equal.

13. A localized deposition system as claimed in claim 1 wherein the deposition control system comprises at least one programmable controller in communication with the substrate support, a feed material supply, a feedstock laser source, a substrate laser source.

14. A localized deposition system as claimed in claim 1 wherein the substrate support comprises a multi-dimensional substrate positioner that provides for relative movement, in at least two dimensions, between the deposition surface of the substrate and the position at which the feed material is provided for localized deposition.

15. A localized deposition system as claimed in claim 1 wherein the feed material supply comprises a multi-dimensional feed positioner that provides for relative movement, in at least two dimensions, between the deposition surface of the substrate and the position at which the feed material is provided for localized deposition.

16. A localized deposition system as claimed in claim 1 wherein the feedstock laser source is configured to generate a laser beam of sufficient thermal energy to heat a tip region of the feed material to a temperature at which it can be bonded to the deposition surface of the substrate through a thermal wetting process.

17. A localized deposition system as claimed in claim 16 wherein the substrate laser source is configured to generate a laser beam of sufficient thermal energy to contribute to the thermal wetting process by heating the localized portion of the substrate.

18. A method of localized deposition comprising:
supporting a glass or glass ceramic substrate such that a deposition surface of the substrate is in communication with a glass or glass ceramic feed material supply;
utilizing the feed material supply to provide glass or glass ceramic feed material for localized deposition at a localized portion on the deposition surface of the substrate, wherein the substrate has a coefficient of thermal expansion of approximately zero and comprises a glass or a glass ceramic and the feed material has a coefficient of thermal expansion of approximately zero and comprises a glass or a glass ceramic;
utilizing the feedstock laser source to heat feed material positioned for localized deposition on the deposition surface of the substrate, wherein the feedstock laser source is configured to generate a laser beam of sufficient thermal energy to heat a tip region of the glass or glass ceramic feed material to a temperature at which it can be bonded to the deposition surface of the glass or glass ceramic substrate through a thermal wetting process; and
synchronizing relative movement between the deposition surface of the substrate and the localized deposition position of the feed material supply with operation of the feedstock laser source and the feed material supply to execute a deposition operation.

19. A method of localized deposition comprising:
supporting a substrate such that a deposition surface of the substrate is in communication with a feed material supply;
providing feed material from the feed material supply for localized deposition at a localized portion on the deposition surface of the substrate;
moving, relative to one another through a two-dimensional deposition plane, the deposition surface of the substrate and a position in which the feed material is provided for localized deposition;
utilizing a feedstock laser source to generate a laser beam of sufficient thermal energy to heat a tip region of the feed material to a temperature at which it can be bonded to the deposition surface of the substrate through a thermal wetting process;
utilizing a substrate laser source to heat a localized portion of the substrate, wherein the substrate laser source is configured to generate a laser beam of sufficient thermal energy to contribute to the thermal wetting process by heating the localized portion of the substrate; and
synchronizing relative movement between the deposition surface of the substrate and the localized deposition position of the feed material supply with operation of the feedstock laser source, the substrate laser source, and the feed material supply to execute a deposition operation.

20. A method as claimed in claim 19 wherein:
the relative movement of the substrate and the feed material defines a microfluidic device pattern; and
the method further comprises securing a cover plate over the microfluidic device pattern to define at least partially contained microfluidic device channels.
